(19) United States
(12) Patent Application Publication
(10) Pub. No.: US 2014/0174656 A1
(43) Pub. Date: Jun. 26, 2014

(54) Method to Improve the Operational Robustness and Safety of Combinatorial Processing Systems

(71) Applicant: INTERMOLECULAR, INC., San Jose, CA (US)

(72) Inventors: Satbir Kahlon, Livermore, CA (US); Jeffrey Lowe, Cupertino, CA (US)

(73) Assignee: INTERMOLECULAR, INC., San Jose, CA (US)

(21) Appl. No.: 13/722,170

(22) Filed: Dec. 20, 2012

(51) Int. Cl. B05C 11/00

(52) U.S. Cl. CPC B05C 11/00
USPC 156/345.15

(57) ABSTRACT

Methods and apparatuses for combinatorial processing are disclosed. Apparatuses include a wet etch module (WEM) operable to combinatorially etch a substrate having at least two site-isolated regions. The WEM includes a dispense manifold operable to dispense fluids and a mixing vessel unit operable to mix fluids. The WEM further includes a reactor unit operable to receive fluids from the dispense manifold or the mixing vessel unit. The reactor unit can apply a combinatorial process on a substrate having at least two site-isolated regions within the WEM. In addition, a secondary containment unit, having a leak sensor therein, is coupled to the dispense manifold, mixing vessel unit, or reactor unit to receive fluid leaks within the system. When the leak sensor detects a fluid leak, a warning may be generated. Advantageously, the generated warning does not impede substrate processing within the WEM.

### FIELD OF THE INVENTION

The present disclosure relates to methods and apparatuses for increasing the operational robustness and safety of combinatorial processing systems.

### BACKGROUND

An F30™ tool is a combinatorial research and development system which has the capability to accommodate and dispense various fluids. Fluids within the F30 tool are partitioned into two sides and each side has one dispense manifold to deliver fluids to a reactor unit directly or indirectly through a mixing vessel unit. The dispense manifolds can deliver fluids to various mixing vessels from any number of fluid distribution channels.

The dispense manifolds may be coupled to vacuum waste lines such that excess fluid in the fluid distribution channel may be disposed from the system. For example, in the event pressure within any fluid distribution channel exceeds a predetermined threshold, a pressure relief valve coupled thereto releases fluid from the fluid distribution channels into vacuum waste which gets routed to the main leak containment tray (main tray) to be disposed. A leak sensor within the main tray may cause the system to shut down.

Additionally, in the event a mixing vessel gets overfilled, fluid within the vessel gets routed to the main tray which triggers a leak sensor within the main tray to shut down the system.

Each reactor cell of the reactor unit may be equipped with four valves to deliver fluids into the reactor cells or bypass to waste. Because the reactor cells have many connections, the reactor cells are prone to leak at the fittings, valves, or other locations where connections are present. Each reactor unit may have a leak tray to capture fluid spills that route the leaked fluids to the main tray. The leak tray may also be equipped with its own leak sensor which triggers upon detection of fluid therein causing the system to shut down.

Similarly, the individual mixing vessels are constructed with valves and fittings creating a potential source for leaks. The mixing vessel unit may also have a leak tray therein. In conventional F30 tools, leaks at the mixing vessel unit are diverted to the main tray.

When a leak is detected in the main tray, system faults shut down each sub-system within the F30 tool and stops processing substrates within the system. For example, the system's main vacuum system shuts down thereby disabling the vacuum from the auxiliary lines. As a result, cleaning the spill from the main tray requires bypassing (e.g. overriding) the sub-systems. Accordingly, serious safety hazards arise from bypassing sub-systems within the combinatorial processing tool (e.g. vacuum system).

During recovery, a technician could forget to re-engage the leak sensors thereby creating a hazardous condition. Additionally, manually cleaning the main tray without using auxiliary vacuum lines could expose a technician to unknown chemistries. Lastly, shutting down the system prematurely as a result of leak detection may produce wafer scrap.

In addition, the recovery process may require a technician to manually remove a semi-processed wafer, initiate a spin, rinse and dry sequence in the spin-rinse-dry (SRD) module, or subsequently place the wafer into the wafer holder (e.g. a Front Opening Unified Pod (FOUP). If a technician, operator, or other user is not proficient in recovery processes, an accident may occur.

Accordingly, what is needed is a system that allows fluid leak detection, cleanup, and safe recovery of combinatorial processing systems. The present invention addresses such a need.

### SUMMARY OF THE DISCLOSURE

The following summary is included in order to provide a basic understanding of some aspects and features of the present disclosure. This summary is not an extensive overview of the disclosure and as such it is not intended to particularly identify key or critical elements of the disclosure or to delineate the scope of the disclosure. Its sole purpose is to present some concepts of the disclosure in a simplified form as a prelude to the more detailed description that is presented below.

Methods and apparatuses for combinatorial processing are disclosed. Apparatuses include a wet etch module (WEM) operable to combinatorially etch a substrate having at least two site-isolated regions. The WEM includes a dispense manifold operable to dispense fluids and a mixing vessel unit operable to mix fluids. The WEM further includes a reactor unit operable to receive fluids from the dispense manifold or the mixing vessel unit. The reactor unit can apply a combinatorial process on a substrate having at least two site-isolated regions within the WEM. In addition, a secondary containment unit, having a leak sensor therein, is coupled to the dispense manifold, mixing vessel unit, or reactor unit to receive fluid leaks within the system. When the leak sensor detects a fluid leak, a warning may be generated. Advantageously, the generated warning does not impede substrate processing within the WEM.

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not necessarily to scale. The techniques of the present disclosure may readily be understood by considering the following detailed description in conjunction with the accompanying drawings, in which:

FIG. 1 is a schematic diagram for implementing combinatorial processing and evaluation.

FIG. 2 is a schematic diagram for illustrating various process sequences using combinatorial processing and evaluation.

FIG. 3 is a simplified schematic diagram illustrating an integrated high productivity combinatorial (HPC) system.

FIG. 4 is a simplified schematic diagram illustrating a wet etch module of a combinatorial processing system which may incorporate processing experiments or semiconductor manufacturing process sequences and unit operations in order to combinatorially evaluate various semiconductor manufacturing processes.

FIG. 5 is a simplified schematic diagram illustrating a dispense manifold operable within a wet etch module of a combinatorial processing system.

FIG. 6A is a simplified schematic diagram illustrating a mixing vessel unit operable within a wet etch module.

FIG. 6B is a simplified schematic diagram illustrating an individual mixing vessel operable within a mixing vessel unit.

FIG. 7A is a simplified schematic diagram illustrating a reactor unit within a partially configured combinatorial processing system.

FIG. 7B is a simplified schematic diagram illustrating an individual reactor cell within a reactor unit.

FIG. 8 illustrates one example of a substrate having a pattern of site-isolated regions.

FIG. 9 is a simplified schematic diagram illustrating a wet etch module of a combinatorial processing system, having a secondary containment unit therein, which may incorporate processing experiments or semiconductor manufacturing process sequences and unit operations in order to combinatorially evaluate various semiconductor manufacturing processes.

FIG. 10A is a simplified schematic diagram illustrating a perspective view of a secondary containment unit.

FIG. 10B is a simplified schematic diagram illustrating a top view of a secondary containment unit.

### DETAILED DESCRIPTION

Methods and apparatuses for combinatorial processing are disclosed. Apparatuses include a wet etch module (WEM) operable to combinatorially etch a substrate having at least two site-isolated regions. The WEM includes a dispense manifold operable to dispense fluids and a mixing vessel unit operable to mix fluids. The WEM further includes a reactor unit operable to receive fluids from the dispense manifold or the mixing vessel unit. The reactor unit can apply a combinatorial process on a substrate having at least two site-isolated regions within the WEM. In addition, a secondary containment unit, having a leak sensor therein, is coupled to the dispense manifold, mixing vessel unit, or reactor unit to receive fluid leaks within the system. When the leak sensor detects a fluid leak, a warning may be generated. Advantageously, the generated warning does not impede substrate processing within the WEM.

It is to be understood that unless otherwise indicated this disclosure is not limited to specific layer compositions or surface treatments. It is also to be understood that the terminology used herein is for the purpose of describing particular embodiments only and is not intended to limit the scope of the present disclosure.

It must be noted that as used herein and in the claims, the singular forms “a,” and “the” include plural referents unless the context clearly dictates otherwise. Thus, for example, reference to “a layer” also includes two or more layers, and so forth.

Where a range of values is provided, it is understood that each intervening value, to the tenth of the unit of the lower limit unless the context clearly dictates otherwise, between the upper and lower limit of that range, and any other stated or intervening value in that stated range, is encompassed within the disclosure. The upper and lower limits of these smaller ranges may independently be included in the smaller ranges, and are also encompassed within the disclosure, subject to any specifically excluded limit in the stated range. Where the stated range includes one or both of the limits, ranges excluding either or both of those included limits are also included in the disclosure. The term “about” generally refers to ±10% of a stated value.

The term “site-isolated” as used herein refers to providing distinct processing conditions, such as controlled temperature, flow rates, chamber pressure, processing time, plasma composition, and plasma energies. Site isolation may provide complete isolation between regions or relative isolation between regions. Preferably, the relative isolation is sufficient to provide a control over processing conditions within ±10%, within ±5%, within ±2%, within ±1%, or within ±0.1% of the target conditions. Where one region is processed at a time, adjacent regions are generally protected from any exposure that would alter the substrate surface in a measurable way.

The term “site-isolated region” is used herein to refer to a localized area on a substrate which is, was, or is intended to be used for processing or formation of a selected material. The region may include one region and/or a series of regular or periodic regions predefined on the substrate. The region may have any convenient shape, e.g., circular, rectangular, elliptical, wedge-shaped, etc. In the semiconductor field, a region may be, for example, a test structure, single die, multiple dies, portion of a die, other defined portion of substrate, or an undefined area of a substrate, e.g., blanket substrate which is defined through the processing.

The term “substrate” as used herein may refer to any workpiece on which formation or treatment of material layers is desired. Substrates may include, without limitation, silicon, coated silicon, other semiconductor materials, glass, polymers, metal foils, etc. The term “substrate” or “wafer” may be used interchangeably herein. Semiconductor wafer shapes and sizes may vary and include commonly used round wafers of 2″, 4″, 200 mm, or 300 mm in diameter.

It is desirable to be able to i) test different materials, ii) test different processing conditions within each unit process module, iii) test different sequencing and integration of processing modules within an integrated processing tool, iv) test different sequencing of processing tools in executing different process sequence integration flows, and combinations thereof in the manufacture of devices. In particular, there is a need to be able to test i) more than one material, ii) more than one processing condition, iii) more than one sequence of processing conditions, iv) more than one process sequence integration flow, and combinations thereof, collectively known as “combinatorial process sequence integration”, on a single substrate without the need of consuming the equivalent number of monolithic substrates per material(s), processing condition(s), sequence(s) of processing conditions, sequence(s) of processes, and combinations thereof. This may greatly improve both the speed and reduce the costs associated with the discovery, implementation, optimization, and qualification of material(s), process(es), and process integration sequence(s) required for manufacturing.

Systems and methods for HPC™ processing are described in U.S. Pat. No. 7,544,574 filed on Feb. 10, 2006; U.S. Pat. No. 7,824,935 filed on Jul. 2, 2008; U.S. Pat. No. 7,871,928 filed on May 4, 2009; U.S. Pat. No. 7,902,063 filed on Feb. 10, 2006; and U.S. Pat. No. 7,947,531 filed on Aug. 28, 2009 which are all herein incorporated by reference for all purposes. Systems and methods for HPC™ processing are further described in U.S. patent application Ser. No. 11/352,077 filed on Feb. 10, 2006, claiming priority from Oct. 15, 2005; U.S. patent application Ser. No. 11/419,174 filed on May 18, 2006, claiming priority from Oct. 15, 2005; U.S. patent application Ser. No. 11/674,132 filed on Feb. 12, 2007, claiming priority from Oct. 15, 2005; and U.S. patent application Ser. No. 11/674,137 filed on Feb. 12, 2007, claiming priority from Oct. 15, 2005 which are all herein incorporated by reference for all purposes.

HPC™ processing techniques have been successfully adapted to wet chemical processing such as etching, texturing, polishing, cleaning, etc. HPC™ processing techniques have also been successfully adapted to deposition processes such as physical vapor deposition (PVD) (i.e. sputtering), atomic layer deposition (ALD), and chemical vapor deposition (CVD).

In addition, systems and methods for combinatorial processing and further described in U.S. patent application Ser. No. 13/341,993 filed on Dec. 31, 2011 and U.S. patent application Ser. No. 13/302,730 filed on Nov. 22, 2011 which are all herein incorporated by reference for all purposes.

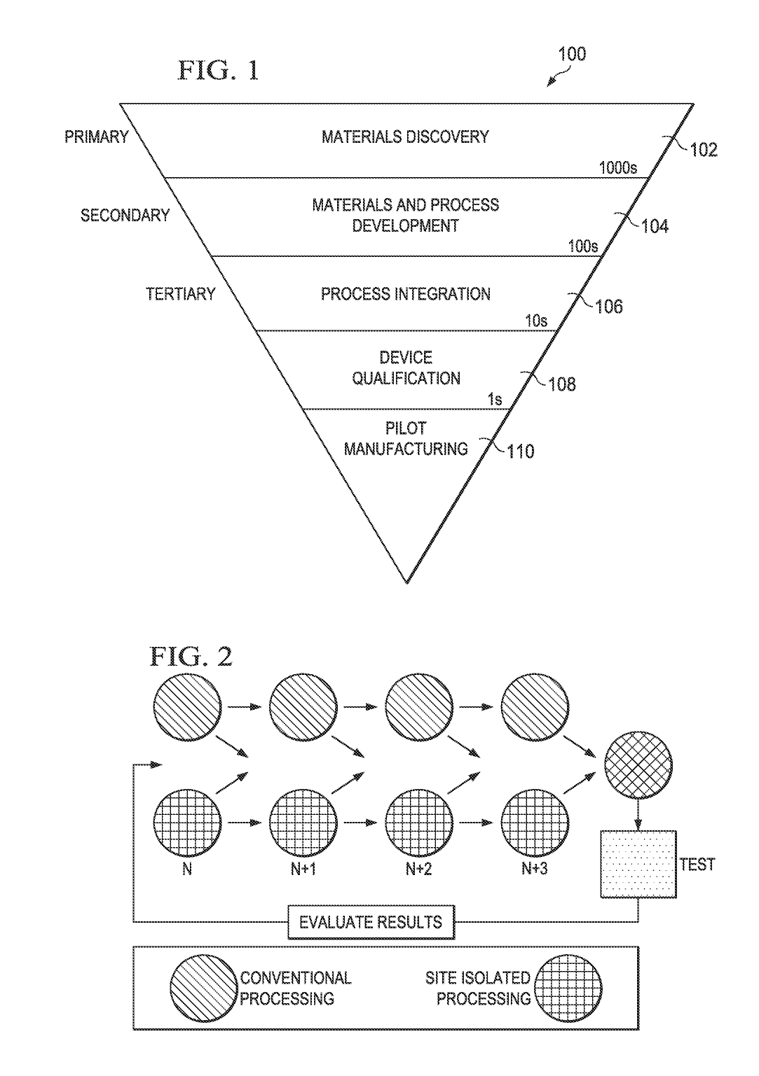

FIG. 1 illustrates a schematic diagram, 100, for implementing combinatorial processing and evaluation using primary, secondary, and tertiary screening. The schematic diagram, 100, illustrates that the relative number of combinatorial processes run with a group of substrates decreases as certain materials and/or processes are selected. Generally, combinatorial processing includes performing a large number of processes during a primary screen, selecting promising candidates from those processes, performing the selected processing during a secondary screen, selecting promising candidates from the secondary screen for a tertiary screen, and so on. In addition, feedback from later stages to earlier stages may be used to refine the success criteria and provide better screening results.

For example, thousands of materials are evaluated during a materials discovery stage, 102. Materials discovery stage, 102, is also known as a primary screening stage performed using primary screening techniques. Primary screening techniques may include dividing substrates into coupons and depositing materials using varied processes. The materials are then evaluated, and promising candidates are advanced to the secondary screen, or materials and process development stage, 104. Evaluation of the materials is performed using metrology tools such as electronic testers and imaging tools (i.e. microscopes).

The materials and process development stage, 104, may evaluate hundreds of materials (i.e., a magnitude smaller than the primary stage) and may focus on the processes used to deposit or develop those materials. Promising materials and processes are again selected, and advanced to the tertiary screen or process integration stage, 106, where tens of materials and/or processes and combinations are evaluated. The tertiary screen or process integration stage, 106, may focus on integrating the selected processes and materials with other processes and materials.

The most promising materials and processes from the tertiary screen are advanced to device qualification, 108. In device qualification, the materials and processes selected are evaluated for high volume manufacturing, which normally is conducted on full substrates within production tools, but need not be conducted in such a manner. The results are evaluated to determine the efficacy of the selected materials and processes. If successful, the use of the screened materials and processes may proceed to pilot manufacturing 110.

The schematic diagram, 100, is an example of various techniques that may be used to evaluate and select materials and processes for the development of new materials and processes. The descriptions of primary, secondary, etc. screening and the various stages, 102-110, are arbitrary and the stages may overlap, occur out of sequence, be described and be performed in many other ways.

This application benefits from HPC™ techniques described in U.S. patent application Ser. No. 11/674,137 filed on Feb. 12, 2007 which is hereby incorporated for reference for all purposes. Portions of the '137 application have been reproduced below to enhance the understanding of the present disclosure.

While the combinatorial processing varies certain materials, unit processes, hardware details, or process sequences, the composition or thickness of the layers or structures or the action of the unit process, such as cleaning, surface preparation, deposition, surface treatment, etc. is substantially uniform through each discrete site-isolated region. Furthermore, while different materials or unit processes may be used for corresponding layers or steps in the formation of a structure in different site-isolated regions of the substrate during the combinatorial processing, the application of each layer or use of a given unit process is substantially consistent or uniform throughout the different site-isolated regions in which it is intentionally applied. Thus, the processing is uniform within a site-isolated region (inter-region uniformity) and between site-isolated regions (intra-region uniformity), as desired. It should be noted that the process may be varied between site-isolated regions, for example, where a thickness of a layer is varied or a material may be varied between the site-isolated regions, etc., as desired by the design of the experiment.

The result is a series of site-isolated regions on the substrate that contain structures or unit process sequences that have been uniformly applied within that site-isolated region and, as applicable, across different site-isolated regions. This process uniformity allows comparison of the properties within and across the different site-isolated regions such that the variations in test results are due to the varied parameter (e.g., materials, unit processes, unit process parameters, hardware details, or process sequences) and not the lack of process uniformity. In the embodiments described herein, the positions of the discrete site-isolated regions on the substrate may be defined as needed, but are preferably systematized for ease of tooling and design of experimentation. In addition, the number, variants and location of structures within each site-isolated region are designed to enable valid statistical analysis of the test results within each site-isolated region and across site-isolated regions to be performed.

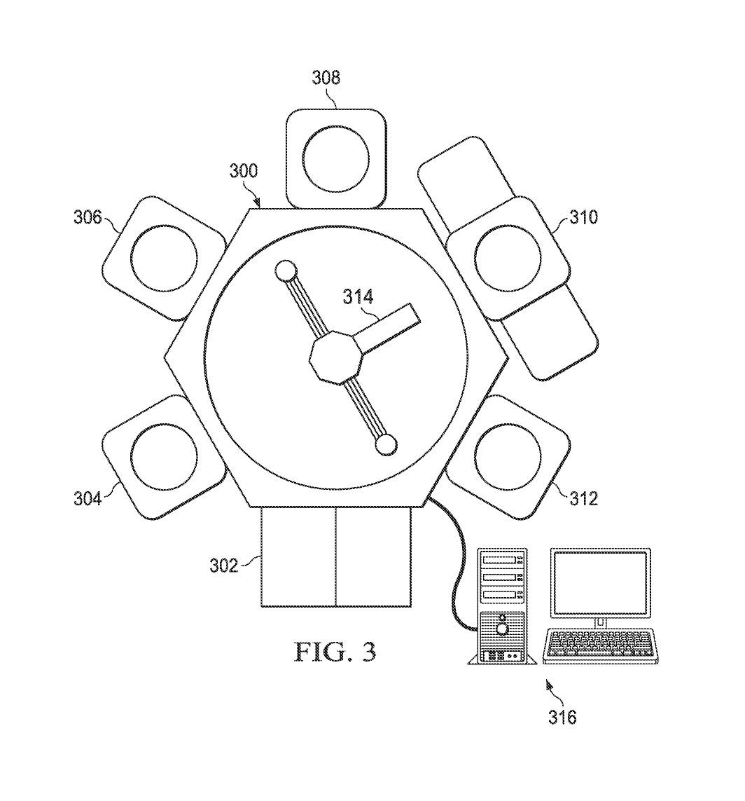

FIG. 2 is a simplified schematic diagram illustrating a general methodology for combinatorial process sequence integration that includes site isolated processing and/or conventional processing. In some embodiments, the substrate is initially processed using conventional process N. In some exemplary embodiments, the substrate is then processed using site isolated process N+1. During site isolated processing, an HPC™ module may be used, such as the HPC module described in U.S. patent application Ser. No. 11/352,077 filed on Feb. 10, 2006, which is incorporated herein by reference for all purposes. The substrate may then be processed using site isolated process N+2, and thereafter processed using conventional process N+3. Testing is performed and the results are evaluated. The testing may include physical, chemical, acoustic, magnetic, electrical, optical, etc. tests. From this evaluation, a particular process from the various site isolated processes (e.g. from steps N+1 and N+2) may be selected and fixed so that additional combinatorial process sequence integration may be performed using site isolated processing for either process N or N+3. For example, a next process sequence may include processing the substrate using site isolated process N, conventional processing for processes N+1, N+2, and N+3, with testing performed thereafter.

It should be appreciated that various other combinations of conventional and combinatorial processes may be included in the processing sequence with regard to FIG. 2. That is, the combinatorial process sequence integration may be applied to any desired segments and/or portions of an overall process flow. Characterization, including physical, chemical, acoustic, magnetic, electrical, optical, etc. testing, may be performed after each process operation, and/or series of process operations within the process flow as desired. The feedback provided by the testing is used to select certain materials, processes, process conditions, and process sequences and eliminate others. Furthermore, the above flows may be applied to entire monolithic substrates, or portions of monolithic substrates such as coupons.

Under combinatorial processing operations the processing conditions at different site-isolated regions may be controlled independently. Consequently, process material amounts, reactant species, processing temperatures, processing times, processing pressures, processing flow rates, processing powers, processing reactant compositions, the rates at which the reactions are quenched, deposition order of process materials, process sequence steps, hardware details, etc., may be varied from site-isolated region to site-isolated region on the substrate. Thus, for example, when exploring materials, a processing material delivered to a first and second site-isolated regions may be the same or different. If the processing material delivered to the first site-isolated region is the same as the processing material delivered to the second isolated-region, this processing material may be offered to the first and second site-isolated regions on the substrate at different concentrations. In addition, the material may be deposited under different processing parameters. Parameters which may be varied include, but are not limited to, process material amounts, reactant species, processing temperatures, processing times, processing pressures, processing flow rates, processing powers, processing reactant compositions, the rates at which the reactions are quenched, atmospheres in which the processes are conducted, an order in which materials are deposited, hardware details of the gas distribution assembly, etc. It should be appreciated that these process parameters are exemplary and not meant to be an exhaustive list as other process parameters commonly used may be varied.

As mentioned above, within a site-isolated region, the process conditions are substantially uniform. That is, the embodiments, described herein locally perform the processing in a conventional manner, e.g., substantially consistent and substantially uniform, while globally over the substrate, the materials, processes, and process sequences may vary. Thus, the testing will find optimums without interference from process variation differences between processes that are meant to be the same. However, in some embodiments, the processing may result in a gradient within the site-isolated regions. It should be appreciated that a site-isolated region may be adjacent to another site-isolated region in some embodiments or the site-isolated regions may be isolated and, therefore, non-overlapping. When the site-isolated regions are adjacent, there may be a slight overlap wherein the materials or precise process interactions are not known, however, a portion of the site-isolated regions, normally at least 50% or more of the area, is uniform and all testing occurs within that site-isolated region. Further, the potential overlap is only allowed with material of processes that will not adversely affect the result of the tests. Both types of site-isolated regions are referred to herein as site-isolated regions or discrete site-isolated regions.

Substrates may be a conventional round 200 mm, 300 mm, or any other larger or smaller substrate/wafer size. In some embodiments, substrates may be square, rectangular, or any other shape. One skilled in the art will appreciate that substrate may be a blanket substrate, a coupon (e.g., partial wafer), or even a patterned substrate having predefined site-isolated regions. In some other embodiments, a substrate may have site-isolated regions defined through the processing described herein.

Software is provided to control the process parameters for each wafer for the combinatorial processing. The process parameters comprise selection of one or more source gases for the plasma generator, plasma filtering parameters, exposure time, substrate temperature, power, frequency, plasma generation method, substrate bias, pressure, gas flow, or combinations thereof.

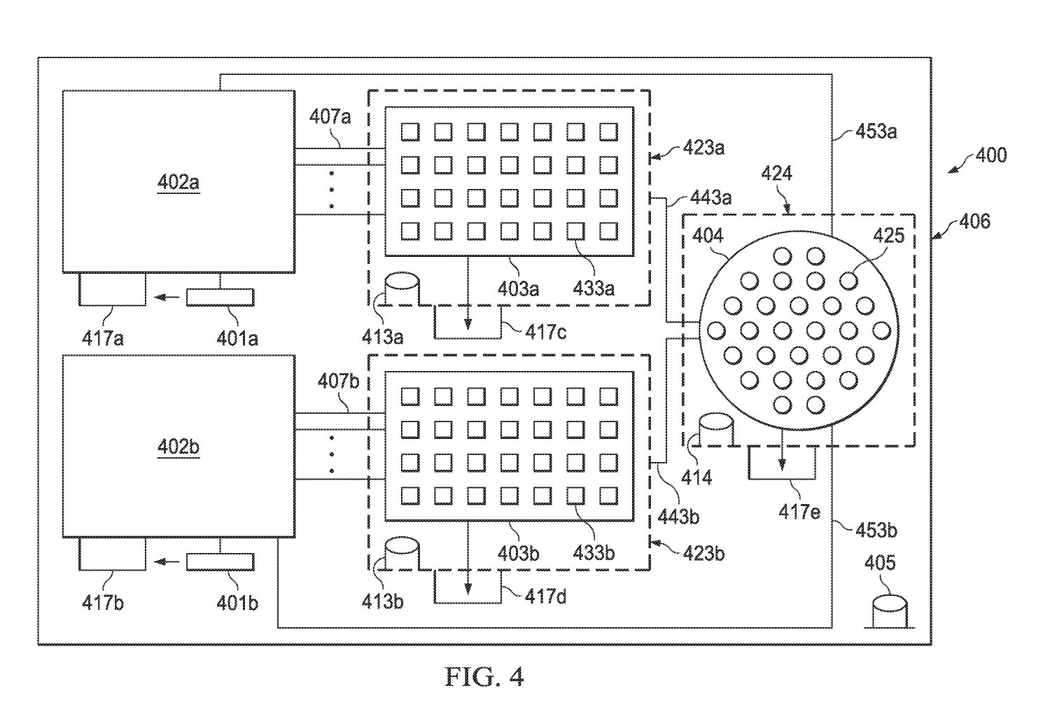

FIG. 3 is a simplified schematic diagram illustrating an integrated high productivity combinatorial (HPC) system. The HPC system includes a frame 300 supporting a plurality of processing modules. It will be appreciated that frame 300 may be a unitary frame in accordance with some embodiments. In some embodiments, the environment within frame 300 is controlled. A load lock 302 provides access into the plurality of modules of the HPC system. A robot 314 provides for the movement of substrates (and masks) between the modules and for the movement into and out of the load lock 302. Modules 304-312 may be any set of modules and preferably include one or more combinatorial modules. For example, module 304 may be an orientation/degassing module, module 306 may be a clean module, either plasma or non-plasma based, modules 308 and/or 310 may be combinatorial/conventional dual purpose modules. Module 312 may provide conventional clean or degas as necessary for the experiment design.

Any type of chamber or combination of chambers may be implemented and the description herein is merely illustrative of one possible combination and not meant to limit the potential chamber or processes that may be supported to combine combinatorial processing or combinatorial plus conventional processing of a substrate or wafer. In some embodiments, a centralized controller, i.e., computing device 316, may control the processes of the HPC system. Further details of one possible HPC system are described in U.S. patent application Ser. Nos. 11/672,473 and 11/672,478, the entire disclosures of which are herein incorporated by reference for all purposes. In a HPC system, a plurality of methods may be employed to deposit material upon a substrate employing combinatorial processes.

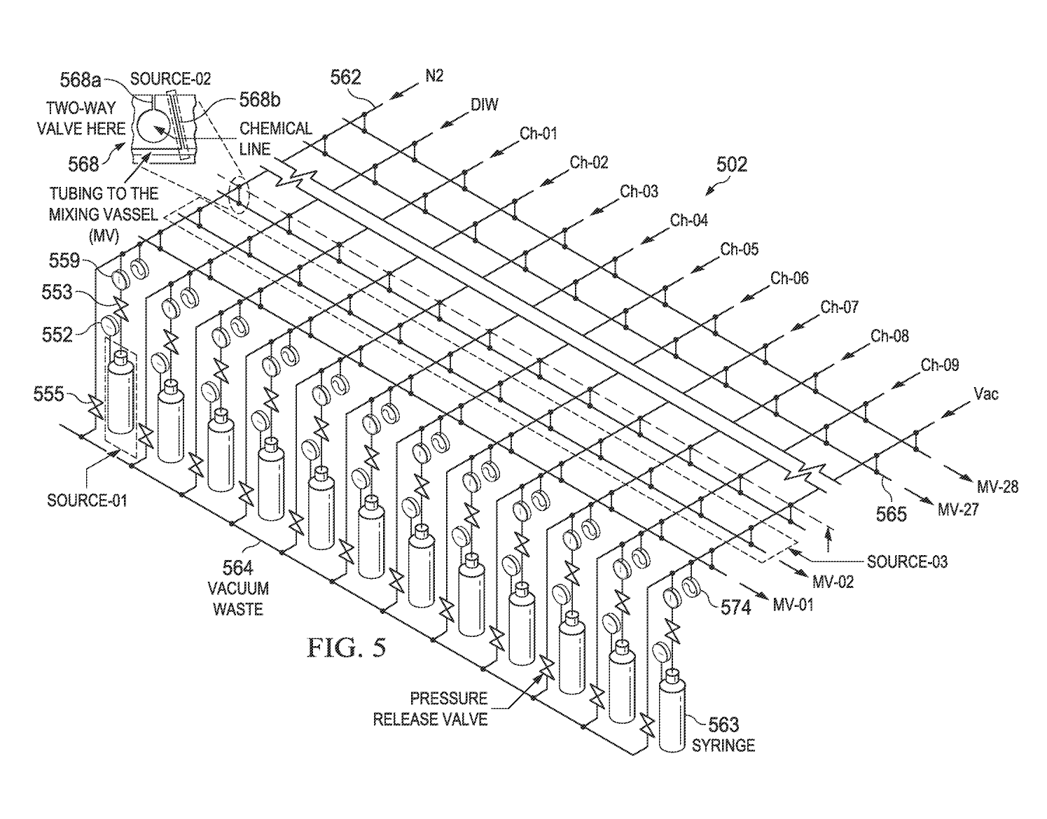

FIG. 4 is a simplified schematic diagram illustrating a wet etch module 400 of a combinatorial processing system which may incorporate processing experiments or semiconductor manufacturing process sequences and unit operations in order to combinatorially evaluate various semiconductor manufacturing processes.

As shown, wet etch module 400 includes a plurality of sub-components and connections. Exemplary sub-components include dispense manifolds 402a, 402b which dispense process fluids throughout the wet etch module 400, mixing vessel units 403a, 403b which optionally mix fluids (e.g. chemicals), and any required power and gas inputs to operate the system. In some embodiments, mixing vessel units 403a, 403b and reactor unit 404 have leak trays to capture fluid leaks at each respective area of the wet etch module 400.

In some embodiments, the leak trays coupled to the mixing vessel unit 403 and reactor unit 404 each have a leak sensor coupled thereto to signal system software about the presence of a fluid leak. As such, in the event a fluid leak is captured in any of the leak trays, the leak sensor coupled thereto sends a signal to system software to subsequently shut down the wet etch module 400 regardless of whether a substrate within the tool has completed processing.

In addition, dispense manifolds 402a, 402b, mixing vessel units 403a, 403b, and reactor unit 404 are coupled to each other component within the wet etch module by fluid distribution lines 407a, 407b, 443a, 443b, 453a, and 453b. Each fluid distribution line delivers fluids to a specific sub-component according to a process recipe. For example, a process recipe may specify that a certain amount of fluids A and B should be mixed together within a mixing vessel and thereafter may be delivered to a reactor cell to process a specific site-isolated region on a substrate.

Furthermore, beneath the wet etch module 400 lies a main tray 406 operable to collect fluid leaks therein. In some embodiments, main tray 406 includes a leak sensor therein and once a fluid leak is detected, the leak sensor 405 sends a message to system software to shut down all sub-systems within the combinatorial processing tool. Accordingly, when the system shuts down the sub-systems, all processing cease, the doors to the combinatorial processing system close, and the vacuum system(s) deactivates. Afterwards, a technician or system operator can clean the fluid leak(s) and remove any substrate(s) located within the combinatorial processing system.

In some embodiments, wet etch module 400 further includes a reactor unit 404 having a plurality of reactor cells 425 to process various site-isolated regions on a substrate. In some embodiments, reactor unit 404 has twenty-eight reactor cells 404 which process twenty-eight site-isolated regions of a 300 mm diameter wafer. In some embodiments, the reactor unit 404 combinatorially etches twenty-eight site-isolated regions of a wafer.

It should be appreciated that any number of reactor cells 425 may be accommodated within the reactor unit 404 so long as reactor unit 404 can combinatorially process a substrate. In some embodiments, the number of reactor cells 425 within the reactor unit 400 depends upon various factors such as the shape and size of the substrate in addition to the shape and size of the site-isolated regions. It should be further appreciated that a monolithic block design or a modular design for the reactor unit 404 may be integrated with some embodiments of the present disclosure.

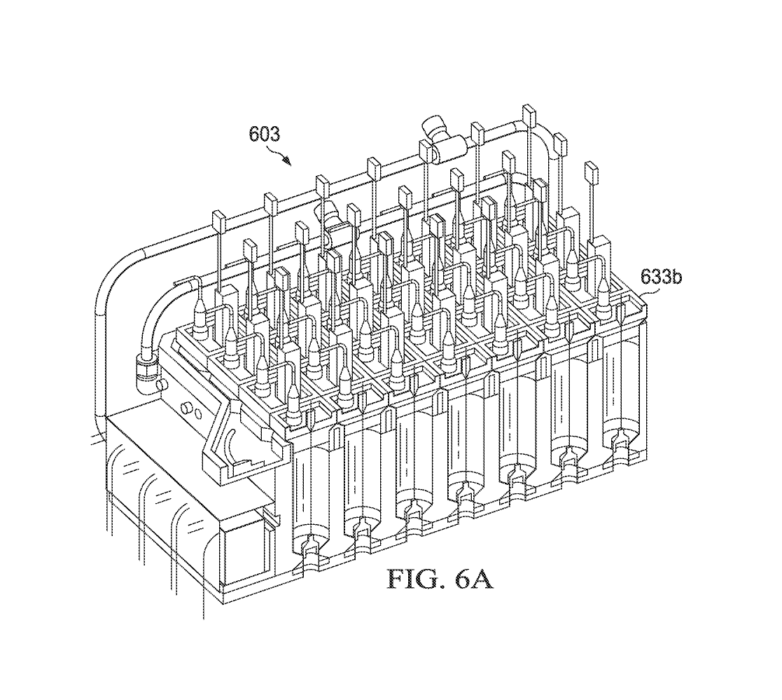

FIG. 5 is a simplified schematic diagram illustrating a dispense manifold 502 operable within a wet etch module of a combinatorial processing system. Dispense manifold 502 includes a plurality of fluid distribution channels 562. Fluid distribution channels 562 may distribute a host of fluids such as, but not limited to, inert gases, deionized water, and process chemicals. In some embodiments, fluid distribution channels 562 include vacuum lines. Further, in some embodiments, each fluid distribution channel 562 is coupled to a fluid source (not shown) which provides fluid to the fluid distribution channels 562. In some embodiments, the fluid sources extend from outside of the combinatorial processing system. In addition, each fluid distribution channel 562 may be coupled to a plurality of fluid distribution lines 565 to deliver fluids to mixing vessel units or directly to a reactor unit according to some embodiments.

Further, dispense manifold 502 may be coupled to vacuum waste lines 564 such that excess fluid in fluid distribution channels 562 may be disposed from the system. For example, in the event pressure within any fluid distribution channel 562 exceeds a predetermined threshold, a pressure relief valve 574 coupled thereto releases fluid from the fluid distribution channels 562 into vacuum waste lines 564 to be disposed. In some embodiments, pressure relief valve 574 releases only enough fluid from the fluid distribution channels 562 to reduce the pressure therein to a predefined target pressure.

In addition, FIG. 5 shows a plurality of fluid sources 563 (e.g. fluid canisters) which provide fluid to fluid distribution channels 562 and once therein, can be delivered to another component within the wet etch module or bypass to waste. In some embodiments, each fluid source 563 has a syringe (not shown) therein.

For example, fluid sources 563 may contain etchant solutions which may be eventually delivered to a reactor unit (see reactor 404 of FIG. 4) in some form (e.g. fluid within the fluid sources 563 may be mixed with two or more fluids within a mixing vessel) by fluid distribution lines 565 within the combinatorial processing system. In addition, fluid source 563 may have a pressure regulator 552 coupled thereto to monitor the pressure within the fluid source 563.

In some embodiments, a flow meter 559, isolation valves 553, 555, and fluid distribution two-way valves 568 are also coupled to fluid distribution channels 562. In some embodiments, flow meter 559 regulates the flow rate of fluids distributed through fluid distribution channels 562 and the isolation valve 553 controls whether fluid is distributed from the fluid source 563 to the fluid distribution channels 562. Furthermore, an isolation valve 555 may be coupled to each fluid distribution channel 562 and may allow fluid therein to dispense to waste in the event pressure relief valve 574 releases fluid from the fluid distribution channels 562.

In some embodiments, each fluid distribution line 565 within dispense manifold 502 is crossed-drilled with twelve bores as entry for process fluids dispensed by the fluid distribution channels 562 via two-way valves 568. Each two-way valve 568 has an inlet port 568a and an outlet port 568b through which process fluids are delivered to the fluid distribution lines 565 from the fluid distribution channels 562.

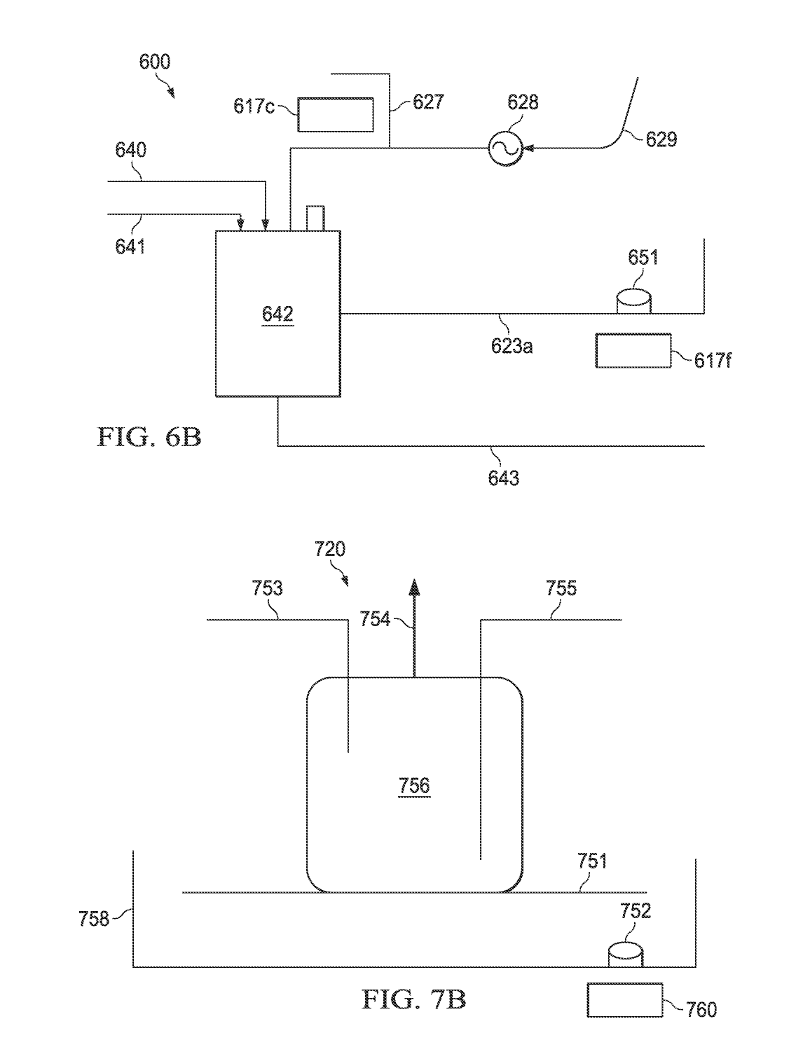

FIG. 6A is a simplified schematic diagram illustrating a mixing vessel unit 603 operable within a wet etch module. In some embodiments, mixing vessel unit 603 includes twenty-eight mixing vessels 633b which mix two or more fluids (e.g. chemicals) therein. For example, various fluids may be mixed within a mixing vessel 633b to produce a desired solution (e.g. etchant) which may be delivered to a reactor cell of a reactor unit to combinatorially process (e.g. etch) various site-isolated regions on a substrate within the processing tool.

FIG. 6B is a simplified schematic diagram illustrating an individual mixing vessel 600 operable within a mixing vessel unit 603. As shown, mixing vessel 600 includes a mixing cell 642 which includes input lines 640, 641 through which fluids are introduced into the mixing vessel 600. In addition, mixing cell 642 also includes at least one output line 643 which routes a mixed fluid to the reactor cell or to waste.

In some embodiments, mixing vessel 600 includes a gas line such as an inert gas line 629 which can be used to control the pressure within the mixing cell 642. In some embodiments, pressure is controlled by a pressure regulator 628 which allows a gas (e.g. inert gas) to be added or removed from the mixing cell 642. In addition, an open line 627 may be coupled to inert gas line 629 such that when an overflow occurs, an alternative path exists for excess fluid to exit the mixing vessel 600. In addition, a vent 617c proximate to open line 627 can be used to route excess fluid to a waste system.

In some embodiments, mixing vessel 600 can contain up to 100 ml of fluid and whenever the vessel 600 gets over filled by fluid, any excess fluid spills over to a leak tray 623a which is filtered to a waste system. For example, when fluid spills into the leak tray 623a, a leak sensor 651 thereto sends a signal to shut down the system.

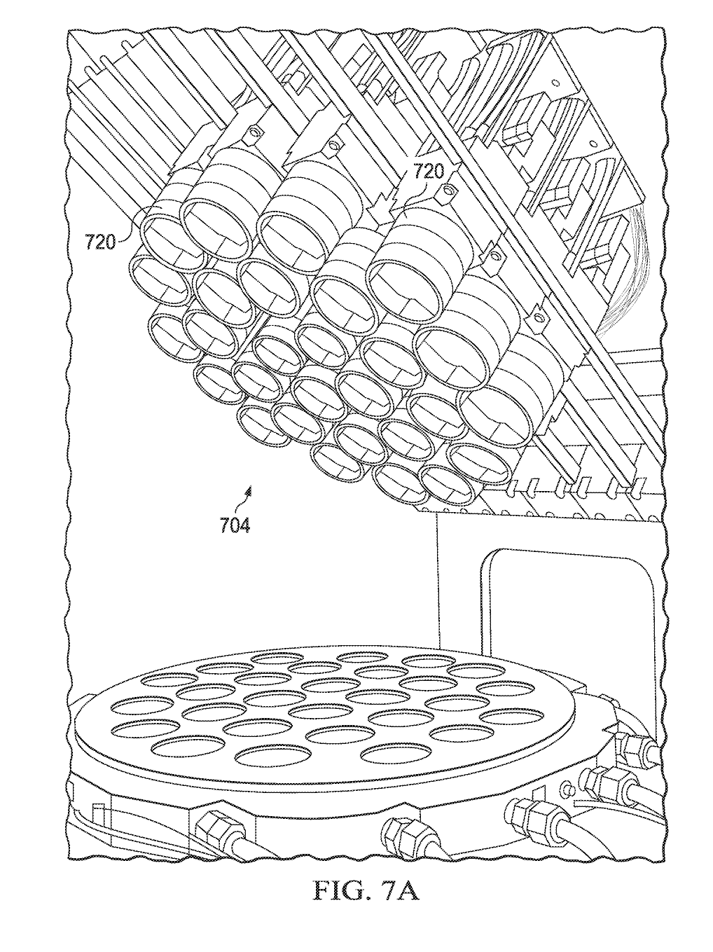

FIG. 7A is a simplified schematic diagram illustrating a reactor unit 704 within a partially configured combinatorial processing system. In some embodiments, reactor unit 704 has twenty-eight sleeves 720, which create a seal with a substrate, to combinatorially process twenty-eight site-isolated regions on a substrate. In some embodiments, fluids are delivered to the reactor unit 704 from a mixing vessel unit or directly from a fluid distribution line. Each reactor cell of the reactor unit 704 may be equipped with four valves to deliver fluids into the reactor cell 720 or bypass the fluids to waste.

In some embodiments, reactor cell 720 includes at least one low vacuum port to remove fluid from the reactor cells, at least one mid vacuum port to maintain a certain fluid level within the reactor cells, and at least one high vacuum port to create a vacuum trap to draw negative pressure into the reactor cells. It should be further appreciated that while reactor cells 720 are depicted as having a certain number of inputs and outputs, they may be varied as the illustrations are exemplary.

In some embodiments, reactor unit 704 is configured to combinatorially process different regions on a substrate. Further details about the reactor cell configuration may be found in U.S. patent application Ser. No. 11/352,077 entitled “Methods for Discretized Processing and Process Sequence Integration of Regions of Substrate” filed on Feb. 10, 2006 and claiming priority to U.S. Provisional Application No. 60/725,186 filed on Oct. 11, 2005 and U.S. patent application Ser. No. 11/966,809 entitled “Vented Combinatorial Processing Cell” filed on Dec. 28, 2007, and claiming priority to U.S. Provisional Application No. 61/014,672 filed 5 on Dec. 18, 2007, the entireties of which are hereby incorporated by reference for all purposes.

FIG. 7B is a simplified schematic diagram illustrating an individual reactor cell 720 within a reactor unit. As shown, reactor cell 720 includes a reactor sleeve 756 which contains a fluid within the perimeter of the reactor sleeve 756. As such, in some embodiments, reactor sleeve 756 can restrict process fluids to the area of a specific site-isolated region on a substrate 751.

Further, reactor cell 720 has vacuum lines coupled to the reactor sleeve 756. For example, reactor cell 720 has a low vacuum line 753, high vacuum line 754, and medium vacuum line 755 coupled thereto to provide a range of negative draws within a reactor sleeve 756.

Furthermore, on the exterior of reactor cell 720 is a leak tray 758 which collects fluids in the event of a leak. In some embodiments, leak tray 758 includes a leak sensor 752 which sends a signal to system software when the leak sensor 752 detects a leak (e.g. fluid). Moreover, in some embodiments, leaks captured by leak tray 758 are routed to vent 760 which delivers the fluid to the main containment leak tray.

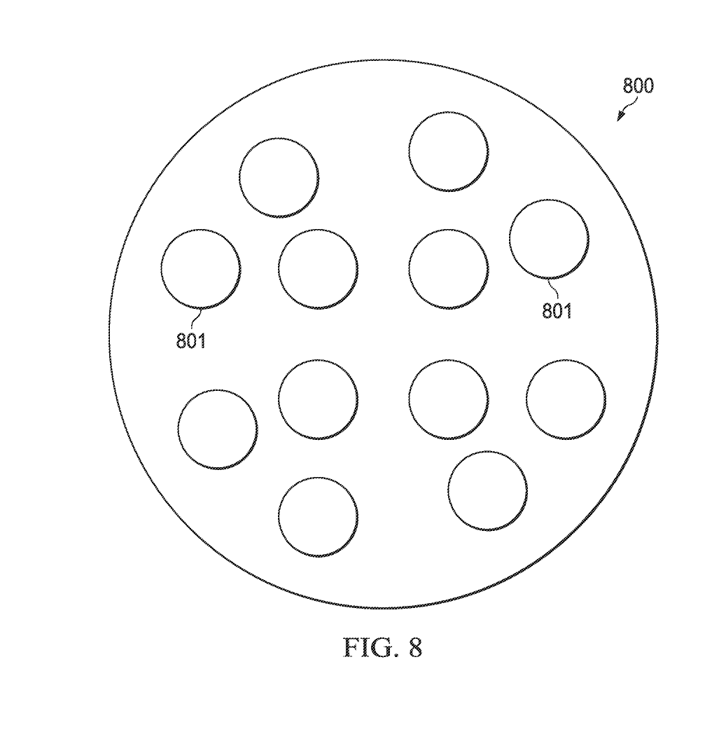

FIG. 8 illustrates one example of a substrate 800 having a pattern of site-isolated regions 801. As shown, the substrate 800 is divided into four quadrants and within each quadrant, three site-isolated regions 801 may be processed yielding twelve site-isolated regions 801 on the substrate 800. Therefore, in this example, twelve independent experiments may be performed on a single substrate 800.

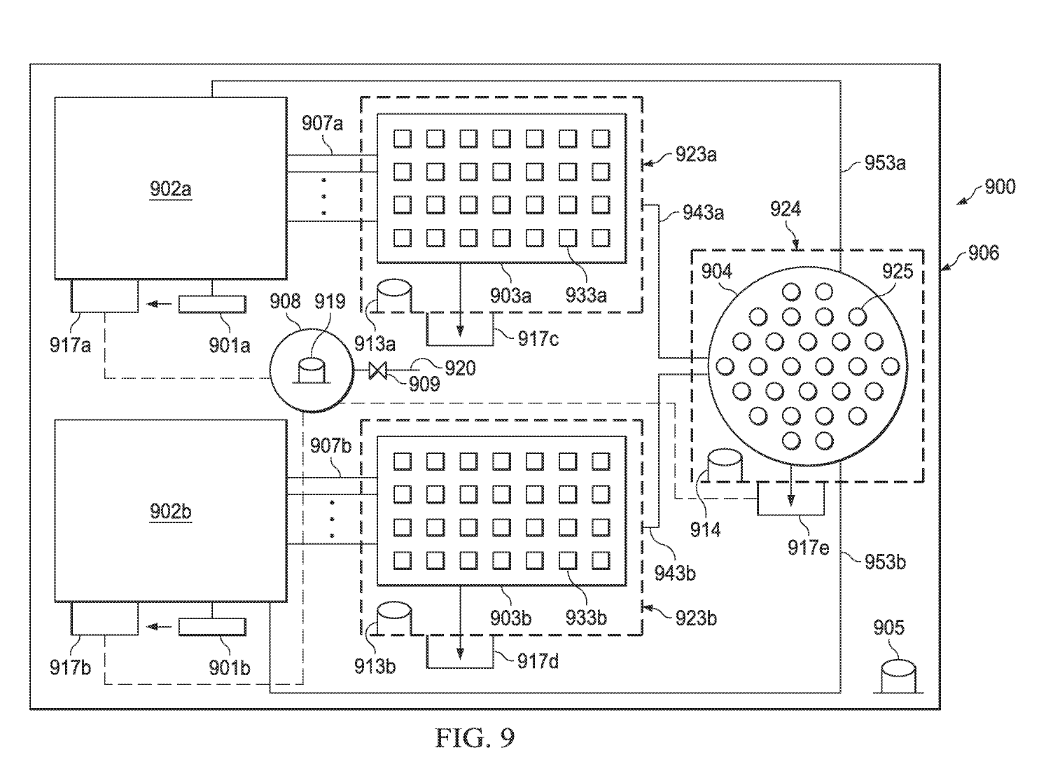

FIG. 9 is a simplified schematic diagram illustrating a wet etch module 900 of a combinatorial processing system, having a secondary containment unit 909 therein, which may incorporate processing experiments or semiconductor manufacturing process sequences and unit operations in order to combinatorially evaluate various semiconductor manufacturing processes.

Combinatorial processing system 900 includes dispense manifolds 902a, 902b, mixing vessel units 903a, 903b, and reactor unit 904. In some embodiments, the components of wet etch module 900 are coupled to vents 917a-917e and are operable to route fluids to a secondary containment unit 908 in the event of leaks.

In some embodiments, combinatorial processing system 900 includes two dispense manifolds 902a, 902b, two mixing vessel units 903a, 903b, and a single reactor unit 904. As shown in the figure, dispense manifolds 902a, 902b are coupled directly to mixing vessel units 903a, 903b by fluid distribution lines 907a, 907b, respectively. In addition, dispense manifolds 902a, 902b are also coupled to reactor unit 904 directly by fluid distribution lines 953a, 953b. Furthermore, mixing vessel units 903a, 903b (having mixing vessels 953a, 953b) are coupled to reactor unit 904 by fluid distribution lines 943a, 943b.

In some embodiments, combinatorial processing system 900 includes two dispense manifolds 902a, 902b, two mixing vessel units 903a, 903b, and a single reactor unit 904. As shown in the figure, dispense manifolds 902a, 902b are coupled directly to mixing vessel units 903a, 903b via fluid distribution lines 907a, 907b, respectively. In addition, dispense manifolds 902a, 902b are also coupled to reactor unit 904 directly by fluid distribution lines 953a, 953b. Furthermore, mixing vessel units 903a, 903b (having a plurality of mixing vessels 933a, 933b) are coupled to reactor unit 904 by fluid distribution lines 943a, 943b.

In some embodiments, dispense manifolds 902a, 902b include pressure relief valves 901a, 901b coupled to the fluid distribution channels therein. In the event pressure within the fluid distribution channels exceed a predefined threshold, pressure relief valves 901a, 901b open and releases fluid into vents 917a, 917b which is subsequently routed into secondary containment 908.

For example, if a fluid leak occurs at any one of mixing vessels 933a, 933b (e.g. valves, tubings, fittings, etc.) and spills into a leak tray 923a coupled thereto, the captured fluid is channeled into vent 917c and routed to secondary containment unit 908. In some embodiments, a leak sensor 913a is coupled to leak tray 923a and sends a signal to system software when a leak is detected in the mixing vessel unit 903a.

Likewise, if a fluid leak occurs at any one of mixing vessels 933b (e.g. valves, tubings, fittings, etc.) and spills into a leak tray 923b coupled thereto, the captured fluid is channeled into vent 917d and routed to secondary containment unit 908. Once a leak sensor 913b detects fluid within the leak tray 923b, the sensor 913b sends a signal to system software that a fluid leak has occurred at mixing vessel unit 903b.

Further, in some embodiments, reactor unit 904 includes a leak tray 924 which captures fluid leaks. In some embodiments, when fluid reaches leak tray 924, a leak sensor 914 therein sends a signal to system software that a fluid leak has occurred at one of the reactor cells 925. Furthermore, once fluid is captured in leak tray 924, the captured fluid is routed to secondary containment unit 908 by vent 917e.

In some embodiments, secondary containment unit 908 includes a leak sensor 919 disposed inside as shown in FIG. 9. In some embodiments, when leak sensor 919 detects a chemical leak, a signal is sent to system software which subsequently updates the status of the system. In some embodiments, the system software issues a WARNING status to alert and inform the tool owner or operator that a fluid leak has been detected in the secondary containment unit 908.

In some embodiments, system software allows the wet etch module 900 to continue processing a substrate loaded within the tool. For example, if a single substrate is being etched in the wet etch portion of the system 900 when the WARNING message is generated, the wet etch module 900 continues processing the substrate until completion (e.g. final step of a process recipe).

In some embodiments, when a leak sensor detects a fluid leak in the secondary containment unit 908, system software prompts a recovery sequence. In some embodiments, the recovery sequence includes prompting a tool operator or technician to 1) determine the failure mode, 2) fix the leak, and 3) clean up the leak.

Furthermore, in some embodiments, while the recovery sequence is in operation, the wet etch module 900 prevents processing additional substrates until the recovery sequence is complete. Accordingly, a substrate currently loaded in the combinatorial processing tool when system software generates a WARNING is allowed to continue processing. As such, the recovery sequence reduces wafer scrap. However, no other substrates may be processed until an operation successfully completes the steps prompted by the recovery sequence according to some embodiments.

In some embodiments, during the recovery process a vacuum tank (not shown) empties the secondary containment unit 908. In addition, a recovery panel (not shown) is dedicated to the secondary containment unit 908 which allows operation of an isolation valve 909 to control access to the vacuum tank according to some embodiments of the present disclosure. Alternatively, when the isolation valve 909 is closed, no clear path exists from the secondary containment unit 908 to the vacuum chamber. As such, when the isolation valve 909 is closed, fluids in the secondary containment unit 908 are not removed by the vacuum chamber.

However, when the isolation valve 909 is open, a flow path 920 is created from the secondary containment unit 908 to the vacuum chamber thereby removing the fluid from the secondary containment unit 908. As such, a tool owner or operator can utilize the recovery panel to empty the secondary containment unit 908 by opening the isolation valve 909.

In addition, in the event fluid leaks are not routed to secondary containment unit 908, the main tray 906 remains operable to capture and retain fluid leaks. Main tray 906 may also include a leak sensor 905 which sends a signal to system software when a leak is detected.

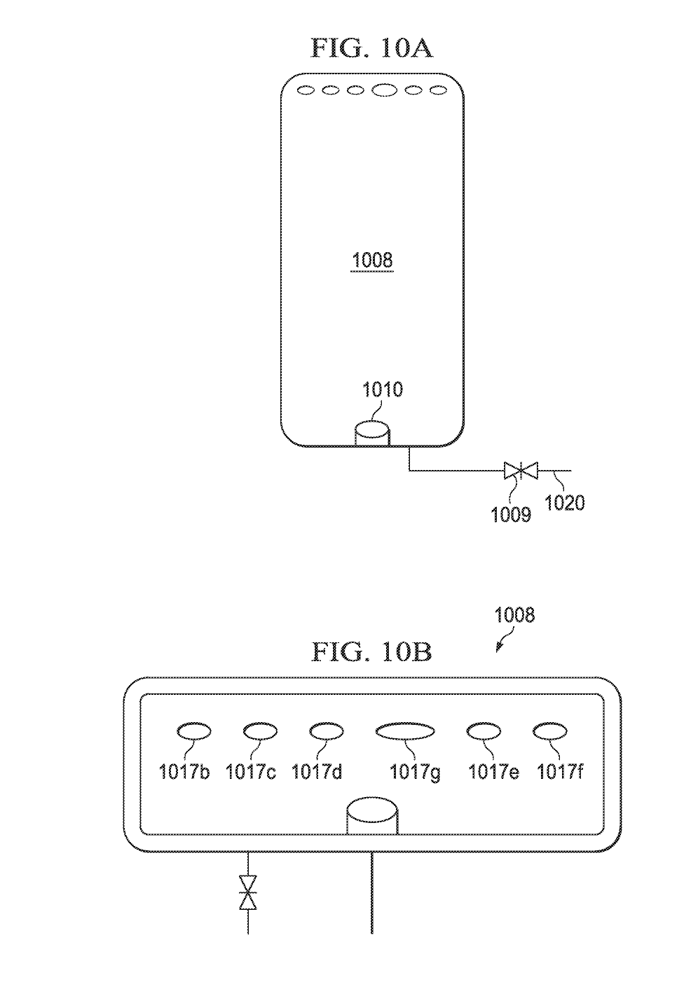

FIG. 10A is a simplified schematic diagram illustrating a perspective view of a secondary containment unit 1008. As shown, secondary containment unit 1008 has a leak sensor 1010 therein and a flow path 1020 coupled thereto leading to vacuum chamber (not shown) by isolation valve 1009. As previously described, the vacuum chamber can remove fluids from the secondary containment unit 1008.

In some embodiments, secondary containment unit 1008 has a volume capacity in the range of 50 mL to 1 L. As such, in the event of a continuous leak, secondary containment unit 1008 can capture and retain up to 1 liter of leaked fluid while a substrate within the tool completes processing. In some embodiments, in the event the secondary containment unit 1008 overfills, the excess fluid spills into the main tray and the system shuts down.

In some embodiments, secondary containment unit 1008 is made of a polytetrafluoroethylene (PTFE) material. In some embodiments, secondary containment unit 1008 contains a perfluoroalkoxy (PFA) material. It should be understood that the present disclosure is not limited to a secondary containment unit 1008 containing PTFE or PFA material. As such, a secondary containment unit 1008 being made of plastic, poly tubing, polymer resin, or material which has a high chemical and temperature resistance. In some embodiments, the melting point of the secondary containment unit 1008 is at least 300° C.

FIG. 10B is a simplified schematic diagram illustrating a top view of a secondary containment unit 1008. As shown, the top view of secondary unit 1008 exposes vent openings 1017b-1017f. In some embodiments, vent opening 1017b-1017f route leaked fluid from the dispense manifold, mixing vessel unit, and reactor unit to the secondary containment unit 1008. In addition, a main tray opening 1017g is operable to provide a failsafe mechanism in the event the secondary containment unit 1008 overflows by routing excess leaked fluid to the main tray.

As such, the secondary containment unit 1008 may be used within a combinatorial processing system to capture overflows and leaks from sleeves, tubings, reactor cells, fittings, etc. within the wet etch module. In some embodiments, the aforementioned leak detection and recovery system can improve recovery time, reduce wafer scrap, minimize human exposure to unknown chemicals, and eliminate manual wafer recovery.

Methods and apparatuses for combinatorial processing have been described. It will be understood that the descriptions of some embodiments of the present disclosure do not limit the various alternative, modified and equivalent embodiments which may be included within the spirit and scope of the present invention as defined by the appended claims. Furthermore, in the detailed description above, numerous specific details are set forth to provide an understanding of various embodiments of the present invention. However, some embodiments of the present invention may be practiced without these specific details.

What is claimed is:

1. A combinatorial processing system, the system comprising:
a wet etch module, wherein the wet etch module is operable to combinatorially etch at least two site-isolated regions on a surface of a substrate;
wherein the wet etch module comprises:
a dispense manifold operable to dispense fluids;
a mixing vessel unit operable to mix at least two fluids wherein the at least two fluids are dispensed from the dispense manifold;
a reactor unit operable to receive at least one fluid from the dispense manifold or the mixing vessel unit;
wherein the reactor unit is operable to process a first site-isolated region on the substrate in a first manner and process a second site-isolated region on the substrate in a second manner;
a secondary containment unit operable to receive fluid leaks from the dispense manifold, mixing vessel unit, or reactor unit;
a main leak containment tray operable to receive fluid leaks from the dispense manifold, mixing vessel unit, reactor unit, or secondary containment unit; and
a first leak sensor coupled to the secondary containment unit and operable to detect a fluid leak wherein upon detecting a fluid leak by the first leak sensor, a warning is generated.
wherein the generated warning allows the processing of a substrate within the wet etch module to finish.

2. The combinatorial processing system of claim 1, wherein the combinatorial processing system includes two dispense manifolds, two mixing vessel units, and one reactor unit.

3. The combinatorial processing system of claim 1, wherein the secondary containment unit is disposed beneath the dispense manifold, mixing vessel unit, and reactor unit.

4. The combinatorial processing system of claim 1 further comprising at least one fluid distribution line coupled to the dispense manifold, wherein the at least one fluid distribution line includes at least one pressure relief valve coupled thereto and operable to route fluids into the secondary containment unit when the pressure within the at least one fluid distribution channel exceeds a threshold pressure.

5. The combinatorial processing system of claim 1, wherein a first leak tray and a second leak sensor are coupled to the mixing vessel unit, a second leak tray and a third leak sensor are coupled to the reactor unit, and a fourth leak sensor is coupled to the main leak containment tray.

6. The combinatorial processing system of claim 1 further comprising system software which can control operation of the dispense manifold, mixing vessel unit, reactor unit, and secondary containment unit.

7. The combinatorial processing system of claim 6, wherein when a fluid leak is detected in the secondary containment unit, the system software is operable to prompt a recovery sequence to determine the source of the fluid leak and to empty the secondary containment unit.

8. The combinatorial processing system of claim 1 further comprising a vacuum tank coupled to the wet etch module which is operable to empty the secondary containment unit.

9. The combinatorial processing system of claim 1, wherein the surface of the secondary containment unit comprises at least one of polytetrafluoroethylene (PTFE) and perfluoroalkoxyl (PFA) material.

10. The combinatorial processing system of claim 1, wherein the secondary containment unit has a volume capacity in the range of 100 mL to 1 L.

11. The combinatorial processing system of claim 1 further comprising a recovery panel which can control an isolation valve coupled to the secondary containment unit to open and close a pathway to a vacuum waste tank coupled to the secondary containment unit.
